(19) United States
(12) Patent Application Publication
(10) Pub. No.: US 2008/0273745 A1
(43) Pub. Date: Nov. 6, 2008

(54) Device including a lens array

(75) Inventor: Roland Bazin, Bievres (FR)

Correspondence Address: OLIFF & BERRIDGE, PLC, P.O. BOX 320850, ALEXANDRIA, VA, 22320-4850, US

(73) Assignee: L'OREAL, Paris (FR)

(21) Appl. No.: 12/081,979

(22) Filed: Apr. 24, 2008

Related U.S. Application Data
(60) Provisional application No. 60/924,292, filed on May 8, 2007.

(30) Foreign Application Priority Data
Apr. 24, 2007 (FR) 07 02954

(51) Int. Cl. G06K 9/46

(52) U.S. Cl. 382/100

(57) ABSTRACT

An evaluation device includes more than three images showing at least two different appearances of keratinous materials, each of the images including an identifier; and an optical system that is configured to make the different images appear in succession as a result of a change in the angle of observation of the device.

This non provisional application claims the benefit of French Application No. 07 02954 filed on Apr. 24, 2007 and U.S. Provisional Application No. 60/924,292 filed on May 8, 2007, the entire contents of each of which are hereby incorporated by reference.

Embodiments of the present invention relate to a novel device for making it easier to provide an evaluation and/or advice in the field of cosmetics. The device may also relate to the use of certain compositions.

### BACKGROUND

European Patent Application No. EP 1 216 658 A1 discloses a method of evaluating a characteristic of the typology of the body. The method is adapted to be implemented using a computer means, thereby requiring, at the very least, the availability of a terminal on which the images can be displayed.

U.S. Patent Application Publication No. 2005/0152041 describes a method of manufacturing images that are visible through a lens array, and that are suitable for appearing, for example, on different products such as a receptacle, a cup, a label, or a package.

U.S. Pat. No. 5,695,346 also describes a method of manufacturing images that are visible through a lens array.

U.S. Pat. No. 4,561,850 describes a device that enables a user to select the colors of different cosmetics as a function of the color of the user's skin and eyes.

### SUMMARY

Embodiments of the invention make available to consumers and professionals, novel tools for making it easier to evaluate a characteristic of body typology and/or for making it easier to select an effect of a makeup or a treatment. Embodiments may also make it easier to use a composition or a device, inter alia.

In one aspect, embodiments provide a device including at least two images showing at least two different appearances of keratinous materials, each of the images including an identifier. The device may further include an optical system that is configured to make the images appear in succession as a result of a change in the angle of observation of the device.

The device may provide a tool that is relatively inexpensive and simple to use for multiple applications in cosmetics.

The expression “keratinous materials” covers the skin of the body and the face, keratinous fibers such as the hair, eyelashes, or eyebrows, the nails, and the lips.

An image can correspond to the local or overall appearance, possibly enlarged or reduced, of a large or small region of the body or of the face. The image may be suitable for showing, for example, only a portion of the face, the entire face, a portion of the body, and/or the entire individual.

The images need not all be to the same scale, for example, the images may be at different magnifications.

In another aspect, embodiments also provide a device including at least two images showing at least two different appearances of keratinous materials and each of the images including an identifier. The device may further include means for enabling the different images to appear in succession at the same location on the device. The means may be an optical system or any mechanical system that makes it possible to substitute one image for another.

The change in the appearance of the keratinous materials from one image to another, when the angle of observation changes, may be progressive. For example, the device may display at least one intermediate image that does not have an identifier between two images that include identifiers.

The optical system may further include a lens array. Disposed behind the lens array may be printed or photographic image data corresponding to the images to be observed through the lens array. The image data may include interleaved strips of images, wherein interleaving may be selected as a function of the optical characteristics of the lens array.

The lenses of the lens array may concentrate the view on different portions of the image data, thereby enabling the images to appear selectively as a function of the angle of observation.

The images may show at least two different degrees of a characteristic of the keratinous materials. By way of example, this characteristic may be selected from: characteristics relating to aging such as: number and depth of wrinkles; sagging of the skin, in particular of the neck; number and depth of folds, in particular of the neck; creasing of the skin; depth of dark rings; level of cellulite; ptosis; and age spots on the skin; physical or morphological characteristics such as: number and size of corneoparticles of the skin; sebum secretion level; sweat secretion level; dryness of the skin or the lips; length, curvature, or density of the eyelashes or the hair; blood supply of the skin; pigmentation defect; density of blackheads; acne; blotches; moles; outline of the lips; and color of the skin or of the hair; typology of the eyelashes or of other portions of the face or of the body; color of the teeth; or color of eye lenses. The characteristics of keratinous materials are not limited to these exemplary lists.

The images of the device may make it possible to identify at least one image that corresponds to a degree that is real or that is desired by the subject. The retained image may serve, for example, as an objective to be achieved as a result of a treatment, or in assessing the effectiveness of a treatment.

The different images may show different makeup effects for the body or for the face. For example, the images may show different makeup effects for the lips, or the eyelashes, or different associations of makeup effects for various portions of the face and/or of the body.

The different images may also show various hair styles or different hair colorings.

The device may include more than three images, indeed more than ten images, e.g. ten to thirty images.

The identifier present on at least one image may include at least one alphanumeric character, e.g. a score, when it is for evaluating some degree of a body-typology characteristic; an age, in particular an apparent age; a reference to a composition when the images that appear correspond, for example, to applying different compositions, or to a duration, e.g. so as to show the effect of a treatment over time.

The identifier may also comprise a marker, e.g. an arrow, the marker being associated with a scale that may be situated outside the optical system. The scale may include a plurality of score, age, or duration values, or references to different compositions or conditions of use for the compositions.

The device may possibly include an opening making it possible to juxtapose keratinous materials and the image that is observed on the device. For example, such an opening may be useful for evaluating the appearance of the skin by making it possible to observe the skin and an image to be compared with the portion of skin that is visible through the opening.

The device may be associated with at least one composition, and the identifier may give information about the use of the composition.

The device may be present on a package of a cosmetic composition or of a food supplement. For example, the device may make it possible to evaluate the subject prior to using the composition or food supplement, with the conditions of application and/or the directions for use possibly depending on the prior evaluation.

In a variant, the presence of the device on the package may inform the user about the effects of the treatment over time.

Embodiments of the invention also may provide a method of evaluating a body-typology characteristic, in which method at least one image of a device as defined above is identified following a comparison with a subject being evaluated.

In another aspect, embodiments may also provide a cosmetic treatment in which at least one image of a device as defined above is identified, and a treatment is performed as a function of the image thus identified.

In another aspect, embodiments may also provide a method of demonstrating an effect of a cosmetic treatment. In embodiments of the method at least one image of a device as defined above is identified prior to the treatment, the treatment is performed, then at least one other image of the device is identified, and, by comparing the images identified both before and after treatment, information is deduced about the effectiveness of the treatment.

In another aspect, embodiments also provide a method of manufacturing a device as defined above. In embodiments of the method, at least one image of keratinous materials of a subject is received from the subject, or at least one image of keratinous materials of the subject is acquired; at least one additional image, in which the appearance of the keratinous materials is modified, is generated at least on the basis of the image thus received or acquired; and a device as defined above, or a similar device, is produced, the images optionally being suitable for including identifiers in this aspect of the invention, the device including at least the additional image thus generated.

The additional image(s) may be generated by image synthesis, e.g. by morphing, so as to make a treatment effect or a makeup effect appear, inter alia.

Thus, in an implementation of embodiments of the invention, from an image of the face of a subject, a plurality of images are generated that correspond to different makeup effects or to different treatments, or indeed to different stages of a treatment, thereby helping the subject to select a makeup effect or to decide for or against a treatment.

The initial image that is received from or taken of the subject, and from which the additional image(s) are generated, may optionally be included in the images of the device and may possibly be disposed outside the optical system.

In another aspect, embodiments may also provide a method that makes it possible to treat, in particular to treat cosmetically, an external portion of the body of an individual. Embodiments of the method include the following steps: generating, by means of a lens array, a sequence of images that simulate various degrees of at least one typological characteristic of an external portion of the body; enabling at least one image to be identified within the sequence that substantially corresponds to some degree of the characteristic; and determining a treatment for the external portion as a function of the at least one identified image.

In another aspect, embodiments may also provide a method that makes it possible to evaluate a treatment for an external portion of the body of an individual. Embodiments of the method include the following steps: generating, by means of a lens array, a sequence of images that simulate various degrees of at least one characteristic of an external portion of the body; enabling at least one image to be identified within the sequence that substantially corresponds to some degree of the at least one characteristic before treatment; treating the external portion of the body of the individual; enabling a further identification and evaluation to be performed after the treatment; and enabling the before and after treatment evaluations to be compared.

### BRIEF DESCRIPTION OF THE DRAWINGS

The invention can be better understood on reading the following detailed description of non-limiting embodiments thereof, and on examining the accompanying drawings, in which:

FIG. 1 illustrates an exemplary embodiment of various images being displayed with exemplary corresponding identifiers;

FIG. 2 is an exemplary diagrammatic and fragmentary cross-section of a lens array that is suitable as an exemplary optical system;

FIG. 3 illustrates an exemplary device on a package;

FIG. 4 illustrates an exemplary embodiment of identifiers;

FIG. 5 illustrates an exemplary production line enabling an exemplary personalized device to be made;

FIG. 6 illustrates an exemplary device for choosing a composition or conditions of application;

FIG. 7 illustrates another exemplary device for choosing a composition or conditions of application;

FIG. 8 illustrates an exemplary packaging and applicator device associated with the device of FIG. 7;

FIG. 9 illustrates exemplary images that form an exemplary device;

FIG. 10 illustrates exemplary images that form an exemplary device; and

FIG. 11 illustrates an exemplary device.

### DETAILED DESCRIPTION OF EMBODIMENTS

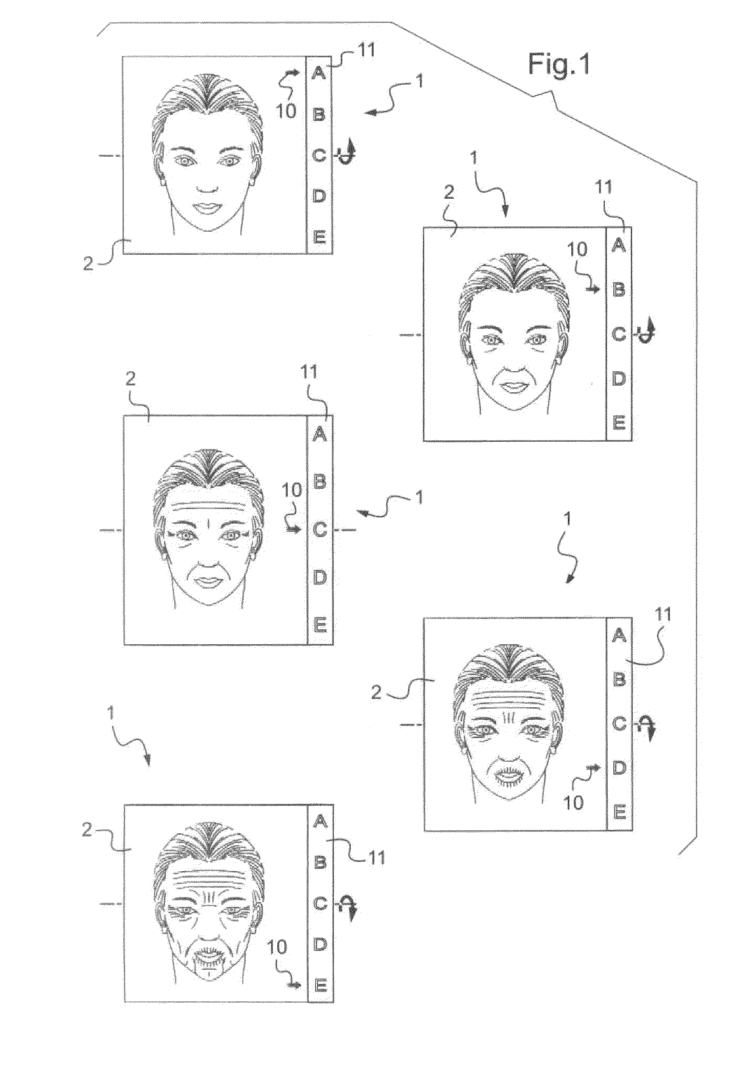

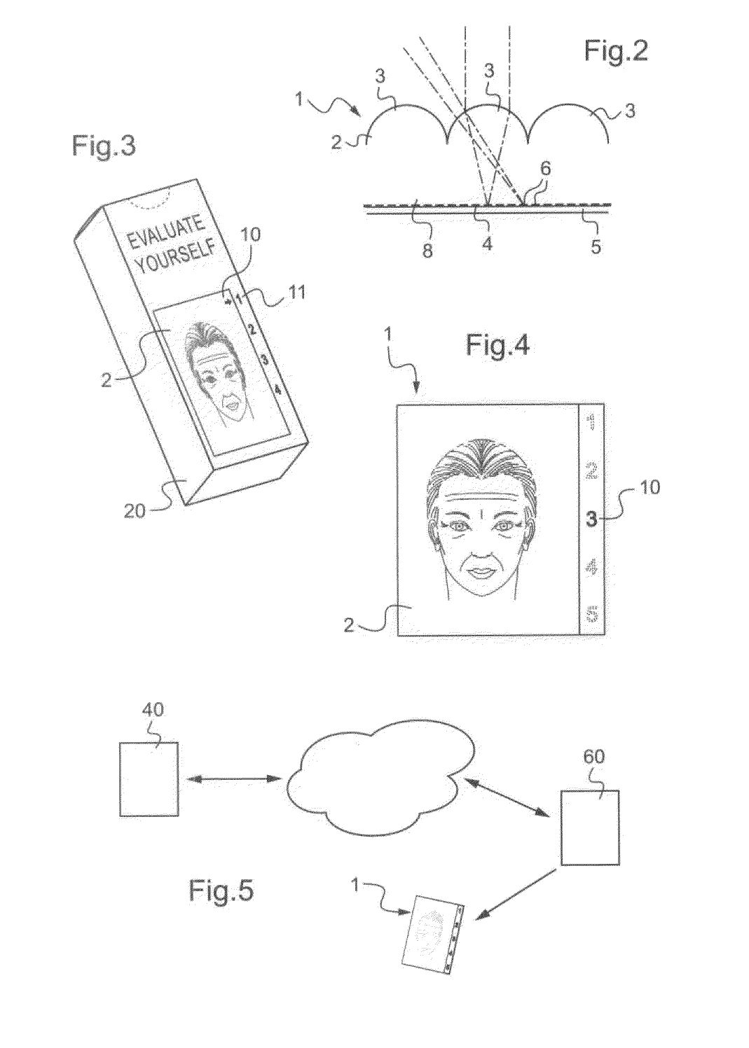

The device 1 shown in FIGS. 1 and 2 includes a lens array, of structure known per se, including juxtaposed lenses 3 of small size, each of which is constituted by a cylindrical lens, for example.

The lens array 2 may present an outer surface that is fluted; the number of lenses 3 per inch may be greater than or equal to 50, for example.

The lenses 3 of the lens array 2 may be made out of a layer 8 of a thermoplastic material, for example.

The layer 8 made of transparent plastics material may present a smooth rear face 4, and may be fastened on a substrate 5, e.g. a sheet of paper, on which there has been printed image data in the form of interleaved strips, said interleaving being selected as a function of the optical characteristics of the lens array, such that, for a first direction of observation, only the image data corresponding to one of the images to be restored appears to the observer, and for other directions of observation, it is different image data, associated with other images to be displayed, that appears.

Lens arrays as such are widely known and varied, and reference could be made to U.S. Pat. Nos. 6,751,024, 6,414,794, 6,781,761, 6,984,425, and 6,795,250, all of which disclose exemplary configurations.

In a variant not shown, the image data is printed directly onto the rear face of the layer made of transparent plastics material of the lens array.

The device 1 can be made in such a manner that, for example, three to thirty images can appear in succession when the angle of observation of the device is changed, as shown in FIG. 1.

Each image can include an identifier that enables the observer to identify the image being observed. In a variant, only some of the images include an identifier, the other images not having an identifier and serving to provide transitions that are agreeable to the eye between those images that have identifiers.

By way of example, each identifier is a marker 10 that, when the angle of observation of the device changes, the marker 10 moves along a scale 11 of the device including other mentions, as shown in FIG. 1.

The identifier 10 can also be at least one alphanumeric character e.g. a score, as shown in FIG. 4.

A device made in accordance with the invention may be used on a package 20, as shown in FIG. 3, e.g. a package made of cardboard.

Where appropriate, the transparent plastics material layer of the lens array may be made integrally with a receptacle or a box containing the composition.

The images that may be observed on the device may be made in various ways, e.g. being real photographs, synthesized images, drawings, or a mixture thereof.

For example, at least some images may be generated by morphing in order to simulate the change, with age, in one or more body-typology characteristics.

An example of simulating the appearance of the face with age is described in the French Patent Application filed under No. 04 10323.

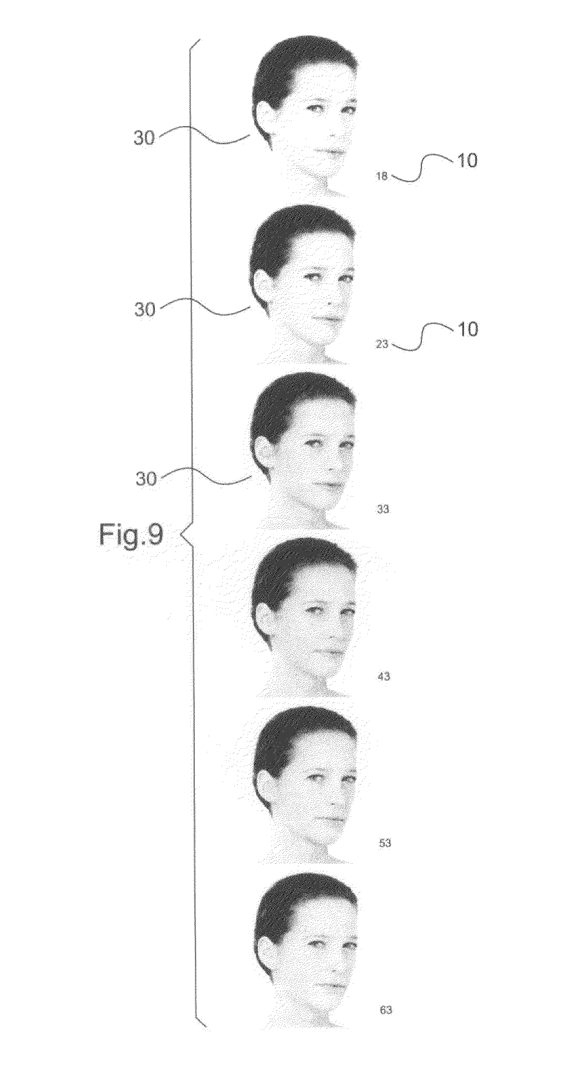

FIG. 9 shows an image sequence 30 simulating the aging process of the face of a woman, with, on each of the images, an identifier constituted by the age that is taken to correspond to the appearance of the woman on the image.

It is possible to decompose only the images shown in FIG. 9 to constitute image data in such a manner as to cause only those images to appear in succession, through the lens array, when the angle of observation of the device varies. In a variant, other images are interposed between the images shown in FIG. 9; the other images do not have identifiers, but present features of the subject that are intermediate between the features of the closest images that are provided with identifiers.

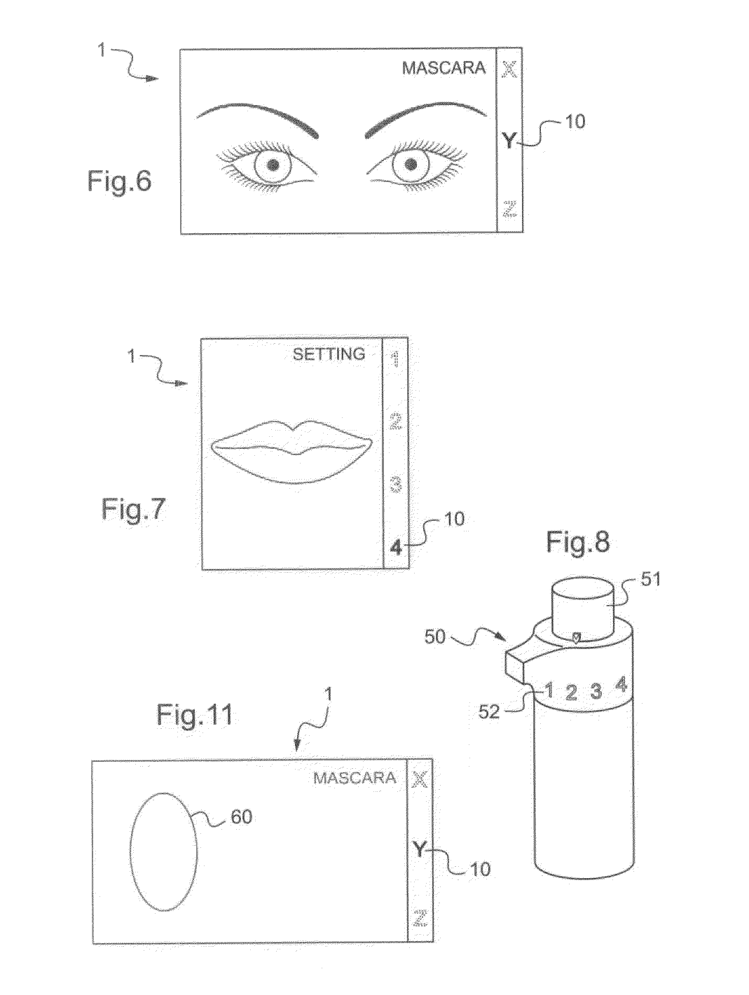

FIG. 6 shows the possibility of using the device 1 to make a plurality of makeup results appear, e.g. eye makeup, the identifier indicating the commercial reference of the mascara to be used to obtain the displayed result, for example.

FIG. 7 shows the possibility of making a plurality of makeup results appear, by means of the device 1, as a function of a particular adjustment of an exemplary packaging device, as shown in FIG. 8, for example. The packaging device 50 includes an adjustment member 51 that makes it possible to vary the relative proportions of two components of a cosmetic used to create a makeup effect, thereby changing the appearance.

The device 1 can indicate to the user the appearance that is likely to be obtained for different settings of the device 50, e.g. marked by identifiers 52 that may correspond to the identifiers 10 incorporated in the images that are likely to be seen by means of the device 1.

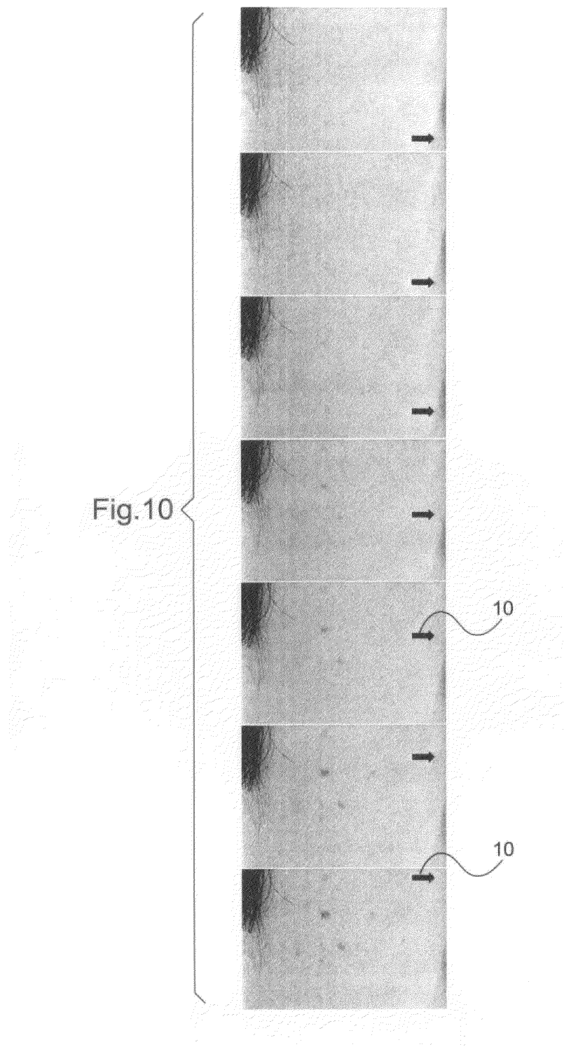

FIG. 10 shows different degrees of aging of the skin, with the appearance of blemishes on the skin as a function of age.

The images can be useful in enabling the observer to evaluate the degree of aging of the observer's skin, or to understand better the appearance of signs of aging, and to decide, for example, on the application of a care product for delaying or alleviating the effects of aging.

In embodiments of FIG. 11, the device includes an opening 60 that makes it possible to see an underlying area of skin. The different images that appear as a function of the angle of observation can thus be compared with the area of skin appearing through the opening 60. For example, the different images may be different skin colors, and the images may for example be produced with inks selected to minimize the phenomenon of metamerism.

The invention is not limited to the various examples described above. For example, it is possible to make the device 1 with means other than an optical system for making a plurality of images appear at the same location, e.g. a mechanical system that makes it possible to move the images relative to one another.

Where appropriate, the device may be proposed to the consumer with a diagnostic tool that makes it possible to stress the skin mechanically, biologically, or chemically, or that makes it possible to observe the skin under special lighting or with a given magnification, for example.

The device 1 could be packaged within a single package with at least one composition for application to the skin or the hair, or with at least one food supplement.

In an exemplary embodiment of the invention, the device is made with at least one image received from a subject or taken of said subject.

For example, a consumer can transmit an image of the consumer's face to an internet site by means of a terminal 40, and the site can transmit the image to a manufacturing unit 60, as shown in FIG. 5.

For example, the terminal 40 may be a phone camera, a webcam, a digital camera, or a video camera. In a variant embodiment of the invention, an image of the individual is sent to the manufacturing unit by post.

In another variant of the invention, an image of the individual is acquired at a point of sale or on the premises of a professional, and the image may be transmitted to the manufacturing unit. The image may also be present at the point of sale.

The manufacturing unit 60 is configured to generate at least one additional image from the received image, e.g. by morphing, so as to end up with a device 1 on which the user may perceive the effects of a treatment or the appearance of modifications resulting from different types of makeup effects, hair styles, or hair colorings, for example.

The received image can optionally be integrated in the device 1.

The invention is not limited to the above-described embodiments.

The expression “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A device comprising:
more than three images showing at least two different appearances of keratinous materials, each of the images including an identifier; and
an optical system that is configured to make the different images appear in succession as a result of a change in the angle of observation of the device.

2. A device comprising:
at least two images showing at least two different appearances of keratinous materials, each of the images including an identifier; and
an optical system that is configured to make the different images appear in succession as a result of a change in the angle of observation of the device, the identifier comprising a marker that is associated with a scale that is situated outside the optical system.

3. A device comprising:
at least two images showing at least two different appearances of keratinous materials, each of the images including an identifier;
an optical system that is configured to make the different images appear in succession as a result of a change in the angle of observation of the device; and
an opening making it possible to juxtapose keratinous materials and at least one image that is observed on the device.

4. A device comprising:
at least two images showing at least two different appearances of keratinous materials, each of the images including an identifier; and
an optical system that is configured to make the different images appear in succession as a result of a change in the angle of observation of the device;
the device being associated with at least one composition, and the identifier providing information about the use of the composition.

5. A device according to claim 1, the optical system including a lens array.

6. A device according to claim 1, the images showing at least two different degrees of a characteristic of the keratinous materials.

7. A device according to claim 6, the characteristic being at least one member selected from the group consisting of:
a characteristic relating to aging; a physical or morphological characteristic; color of the skin or of the hair; typology of the eyelashes or of another region of the face or of the body; color of the teeth; and color of eye lenses.

8. A device according to claim 7, wherein the characteristic relating to aging is at least one member selected from the group consisting of a number and depth of wrinkles; sagging of the skin; number and depth of folds; creasing of the skin; depth of dark rings; level of cellulite; ptosis; and blemishes on the skin.

9. A device according to claim 8, wherein the characteristic relating to aging is at least one member selected from the group consisting of sagging of the skin in the neck and a number and depth of folds in the neck.

10. A device according to claim 7, wherein the physical or morphological characteristic is at least one member selected from the group consisting of a number and size of corneoparticles of the skin; sebum secretion level; sweat secretion level; dryness of the skin or the lips; length, curvature, or density of the eyelashes or the hair; blood supply of the skin; pigmentation defect; density of blackheads; acne; blotches; moles; and outline of the lips.

11. A device according to claim 1, the different images showing different makeup effects for the body or for the face.

12. A device according to claim 2, including more than three images.

13. A device according to claim 1, including more than ten images.

14. A device according to claim 1, the identifier including at least one alphanumeric character.

15. A device according to claim 1, the identifier comprising a marker that is associated with a scale that is situated outside the optical system.

16. A device according to claim 1, including an opening making it possible to juxtapose keratinous materials and at least one image that is observed on the device.

17. A device according to claim 1, being associated with at least one composition, and the identifier giving information about the use of the composition.

18. A package for packaging a cosmetic composition or a food supplement, the package including a device comprising:
at least two images showing at least two different appearances of keratinous materials, each of the images including an identifier; and
an optical system that is configured to make the different images appear in succession as a result of a change in the angle of observation of the device.

19. A method of manufacturing a device including at least two images showing at least two different appearances of keratinous materials, each of the images including an identifier; and an optical system that is configured to make the different images appear in succession as a result of a change in the angle of observation of the device, the method comprising:
receiving at least a first image of keratinous materials of a subject from said subject, or acquiring the first image of keratinous materials of said subject;
generating at least a second image at least on the basis of the received or acquired first image; and
producing the device including at least the generated second image.

20. A method according to claim 19, the second image being generated by image synthesis.

21. A method according to claim 19, in which a plurality of images are generated that correspond to different makeup effects or to different treatments or stages of a treatment.
